(19) United States
(12) Patent Application Publication
(10) Pub. No.: US 2017/0107122 A1
(43) Pub. Date: Apr. 20, 2017

(54) RAW WATER TREATMENT METHOD

(71) Applicant: NAGAOKA INTERNATIONAL CORP., Osaka (JP)

(72) Inventors: Hitoshi MIMURA, Osaka (JP); Tadao OIWA, Osaka (JP); Hui Liang CAI, Osaka (JP); Yoichi YANAGIMOTO, Osaka (JP); Shunsuke MAEDA, Osaka (JP)

(73) Assignee: NAGAOKA INTERNATIONAL CORP., Osaka (JP)

(21) Appl. No.: 15/187,916

(22) Filed: Jun. 21, 2016

Related U.S. Application Data
(63) Continuation of application No. PCT/JP2015/084746, filed on Dec. 11, 2015.

(30) Foreign Application Priority Data
Oct. 16, 2015 (JP) 2015-204340

(51) Int. Cl. C02F 1/28; C02F 1/72; C02F 1/66

(52) U.S. Cl. CPC C02F 1/281; C02F 1/66; C02F 1/72; C02F 2101/103

(57) ABSTRACT

Raw water G containing arsenic in an amount exceeding an environmental standard value is poured into a treatment bath filled with particulate carriers. The raw water G in the treatment bath is treated at a flow rate which does not allow production of ferric hydroxide in a suspended form in the raw water while adding an acidic iron solution to the raw water G so that the pH value of the raw water G is adjusted to 6.5-7.5. A ferric hydroxide membrane is produced on the entire surfaces of the carriers by contact oxidation reaction of dissolvable ferrous ions in the raw water G having the adjusted pH value, to cause the arsenic in the raw water G to be adsorbed on the ferric hydroxide.

### CROSS REFERENCE TO RELATED APPLICATIONS

This application is a continuation of International Application PCT/JP2015/084746 filed on 11 Dec. 2015, which claims benefit of Japanese patent application JP 2015-204340 filed on 16 Oct. 2015, both of which are incorporated herein by reference in their entireties.

### FIELD

The present disclosure relates to a method for efficiently removing arsenic which is contained in raw water, such as groundwater and the like, in an amount exceeding an environmental standard value.

### BACKGROUND

Among the conventionally known methods for efficiently removing arsenic from raw water, such as groundwater or the like, that contains arsenic in an amount exceeding an environmental standard value, is a coprecipitation treatment method as described in Japanese Laid-Open Patent Publication No. H07-289805. In the coprecipitation treatment method, ferric chloride is added to raw water and an oxidizing agent is put into the raw water so that ferric hydroxide in a suspended form is formed. Next, polyaluminum chloride is added so that arsenic and ferric hydroxide aggregate and precipitate in the raw water.

Incidentally, when arsenic and ferric hydroxide are caused to aggregate and precipitate in raw water, it is necessary to prepare 20-40 mg/L of additives such as ferric chloride and polyaluminum chloride or the like with respect to 0.1-0.2 mg/L of arsenic contained in the raw water. In this case, the iron/arsenic ratio (Fe/As) is as high as 100-200.

Thus, in order to remove arsenic in raw water, a large amount of additives (ferric chloride and polyaluminum chloride) which is 100-200 times as large as the amount of arsenic in the raw water is required. In this case, when a large amount of additives is added with respect to arsenic in the raw water, relatively large ferric hydroxide in a suspended form is immediately produced. Therefore, arsenic ions in the raw water are electronically adsorbed only around the ferric hydroxide, resulting in a considerable deterioration in the efficiency of capturing arsenic. In addition, the large amount of additives added increases the operating cost, and the amount of waste additives for removing arsenic is large.

The present disclosure has been made in view of the above, and it is an object of the present disclosure to provide a raw water treatment method in which raw water is treated at a high flow rate while the pH value of the raw water is maintained in the vicinity of neutrality, whereby the production of ferric hydroxide in a suspended form is inhibited, and arsenic in the raw water is caused to be adsorbed on ferric hydroxide which is produced by contact oxidation reaction of iron in a dissolved form which is added or present in the raw water, on the surfaces of fine particulate carriers, and therefore, the efficiency of capturing arsenic can be effectively improved, the increase in operating cost due to additives can be significantly reduced, and the amount of waste additives can be significantly reduced.

### SUMMARY

To achieve the above object, a raw water treatment method according to the present disclosure includes: a first step of pouring raw water containing arsenic in an amount exceeding an environmental standard value, into a treatment bath filled with particulate carriers; a second step of treating the raw water poured in the treatment bath by the first step at a flow rate which does not allow production of ferric hydroxide in a suspended form in the raw water while adding an acidic or alkaline solution to the raw water in the treatment bath so that the pH value of the raw water is adjusted to 6.5-8.5; and a third step of capturing the arsenic in the raw water by producing a membrane of ferric hydroxide on surfaces of the carriers by contact oxidation reaction of iron in a dissolved form which is added to or present in the raw water adjusted by the second step, to cause the arsenic in the raw water to be adsorbed on or complexed with the produced ferric hydroxide.

In the second step, the pH value of the raw water in the treatment bath is preferably adjusted to 6.5-7.5.

In the first step, the raw water is preferably poured into the treatment bath through one end of a raw water/gas-mixing nozzle having an air introduction opening at an intermediate point along the nozzle and having another end connected to a raw water pouring pipe, from above, while air is introduced through the air introduction opening by the ejector effect of the raw water/gas-mixing nozzle sending the raw water at high pressure through the one end of the nozzle, and is mixed with the raw water so that the concentration of dissolved oxygen in the raw water is saturated.

Treated water after the third step or washing water is preferably caused to flow back into the treatment bath on a regular basis for backwashing of the carriers.

Thus, for summary, raw water poured in a treatment bath is treated at a flow rate which does not allow production of ferric hydroxide in a suspended form in the raw water while adding an acidic or alkaline solution to the raw water in the treatment bath so that the pH value of the raw water is adjusted to 6.5-8.5. Arsenic in the raw water is captured by producing ferric hydroxide on the surfaces of carriers by contact oxidation reaction of iron in a dissolved form which is added to or present in the raw water having the pH value adjusted by the second step, to cause the arsenic in the raw water to be adsorbed on the produced ferric hydroxide. Therefore, compared to the situation where arsenic ions are electrically adsorbed only around ferric hydroxide in a suspended form produced in raw water, arsenic ions are electronically adsorbed on or complexed with ferric hydroxide which is produced on the entire surfaces of carriers by contact oxidation reaction of iron in a dissolved form in the raw water on the surfaces of the carriers, so that the arsenic is captured. As a result, arsenic in raw water can be considerably efficiently captured together with iron, and therefore, the efficiency of capturing arsenic can be effectively improved. In addition, because the pH value of raw water can be adjusted to 6.5-8.5 by adding an additive, an increase in operating cost due to the additive can be significantly reduced, and the amount of waste additives can be significantly reduced.

In the second step, the pH value of the raw water in the treatment bath may be adjusted to 6.5-7.5. Thus, arsenic, for which the surface charge is always negative and the amount of the charge increases as the pH value becomes more alkaline, and iron in a dissolved form, for which the amount of the positive surface charge increases as the pH value becomes more acidic from 8.5, efficiently undergo ion adsorption or complexation in a range close to the isoelectric points of arsenic and iron in a dissolved form, so that arsenic is firmly adsorbed on ferric hydroxide covering the entire surfaces of the carriers, and therefore, arsenic in raw water can be considerably efficiently captured together with iron.

In the first step, the concentration of dissolved oxygen in the raw water may be saturated by introducing air into the raw water being sent at high pressure into the treatment bath from above, through the air introduction opening by the ejector effect of the raw water/gas-mixing nozzle. Therefore, the contact oxidation of dissolved iron in the raw water on the surfaces of the carriers to produce ferric hydroxide is facilitated by interaction with the oxidizing power of dissolved oxygen without the need of exposure to air, whereby iron can be efficiently oxidized without the production of colloidal silica iron even when silica or the like is contained in the raw water.

Moreover, treated water after the third step or washing water may be caused to flow back to the treatment bath on a regular basis for backwashing of the carriers, whereby ferric hydroxide produced on the surfaces of the carriers can be washed out together with arsenic adsorbed on the ferric hydroxide with backwashing water (treated water or washing water), and discharged from the treatment bath, and therefore, the carriers can continue to exhibit the effect of treating raw water.

### BRIEF DESCRIPTION OF THE DRAWINGS

FIG. 1 is a general configuration diagram schematically showing an example raw water treatment apparatus that is used in a raw water treatment method according to an embodiment of the present disclosure;

FIG. 2 is a perspective view of a raw water/gas-mixing nozzle used in the raw water treatment apparatus of FIG. 1;

FIG. 3 shows a pH-Eh diagram of an As—Fe—O—H—S system;

FIG. 4 is a characteristic diagram showing changes in the amounts of surface charge of ferric hydroxide and arsenic due to changes in pH;

FIG. 5 is a characteristic diagram showing a relationship between the concentration of arsenic and the amount of an additive (iron solution) in raw water, where a treatment in a treatment bath is conducted at a linear velocity LV of 200 m/day;

FIG. 6 is a characteristic diagram showing a relationship between the concentration of arsenic and the amount of an additive (iron solution) in raw water, where a treatment in a treatment bath is conducted at a linear velocity LV of 400 m/day; and

FIG. 7 is a general configuration diagram schematically showing an example raw water treatment apparatus that is used in a raw water treatment method according to a variation of this embodiment of the present disclosure.

### DESCRIPTION OF EMBODIMENTS

Embodiments of the present disclosure will now be described in detail with reference to the accompanying drawings.

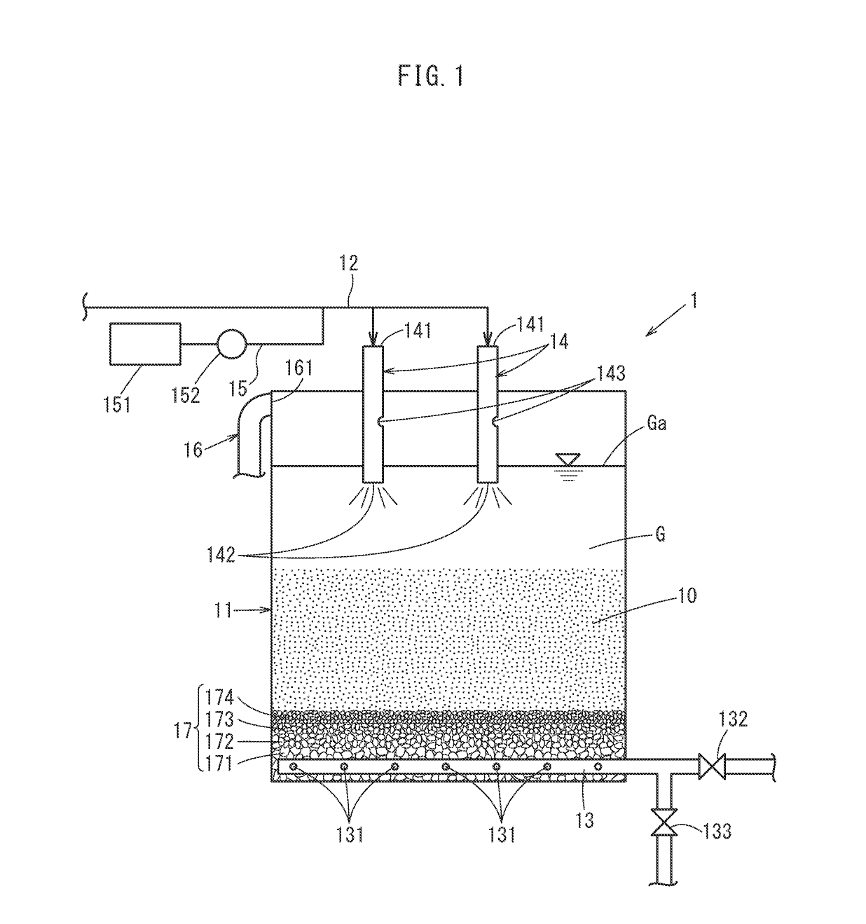

FIG. 1 shows a general configuration diagram schematically showing an example raw water treatment apparatus that is used in a raw water treatment method for removing arsenic from raw water according to an embodiment of the present disclosure.

In FIG. 1, reference numeral 1 indicates a raw water treatment apparatus. The raw water treatment apparatus 1 includes a treatment bath 11 which is filled with particulate carriers 10, a raw water pouring pipe 12 for pouring raw water G into the treatment bath 11, and an extraction pipe 13 for extracting treated water from the treatment bath 11. As the treatment bath 11, a bath having a tube-like shape which is rectangular as viewed from above is used.

The carriers 10 are deposited to a height (e.g., about 1000-1200 mm), which is about 50% of the height of the treatment bath 11, on a support gravel material 17 which is deposited on the bottom of the treatment bath 11 to a height (e.g., about 600 mm), which is about 25% of the height of the treatment bath 11. As the carriers 10, silica sand having a grain size of about 0.6 mm is used. Meanwhile, as the support gravel material 17, four different layers 171-174 of river gravel having different grain sizes are used. The support gravel material 17 includes the lowermost layer 171 made of river gravel having a grain size of about 12-20 mm deposited to a height of about 300 mm, the lower middle layer 172 positioned above the lowermost layer 171 and made of river gravel having a grain size of about 6-12 mm deposited to a height of about 100 mm, the upper middle layer 173 positioned above the lower middle layer 172 and made of river gravel having a grain size of about 3-6 mm deposited to a height of about 100 mm, and the uppermost layer 174 positioned above the upper middle layer 173 and made of river gravel having a grain size of about 1-3 mm deposited to a height of about 100 mm. Although the support gravel material is preferably river gravel, the support gravel material is not limited to this if a similar function is obtained. Also, the carriers 10 are not limited to silica sand, and alternatively, may be anthracite, garnet, or the like.

The raw water pouring pipe 12 is composed of a steel pipe or the like, and a water pump (not shown) is provided thereon. The downstream side of the raw water pouring pipe 12 is extended to a location above the treatment bath 11, where the pipe is bifurcated or divided into two branches. Ends 141, 141 of raw water/gas-mixing nozzles 14, 14 are connected to the ends of the respective branches. The number of the raw water/gas-mixing nozzles 14 is not limited to two, and may be one or more than two.

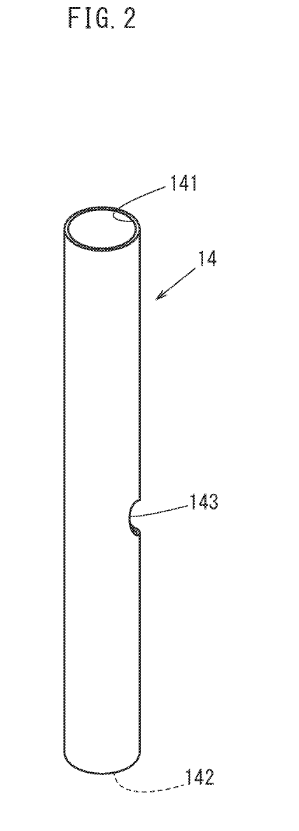

FIG. 2 shows a perspective view of the raw water/gas-mixing nozzle 14 used in the raw water treatment apparatus 1. As shown in FIG. 2, each raw water/gas-mixing nozzle 14 is positioned so that the axis thereof extends in a generally vertical direction. Each raw water/gas-mixing nozzle 14 has, at the other end 142 (lower end) thereof, a raw water ejection opening formed for ejecting jets of the raw water G Each raw water/gas-mixing nozzle 14 has an inner diameter of about 5-30 mm. Each raw water/gas-mixing nozzle 14 has a single air introduction opening 143 in the vicinity of a generally middle portion in the axis direction thereof. The air introduction opening 143 has almost the same size as that of each raw water/gas-mixing nozzle 14.

The raw water G is poured from the raw water pouring pipe 12 through each raw water/gas-mixing nozzle 14 at a flow rate (e.g., linear velocity LV=200-400 m/day) which allows the depth of water in the treatment bath 11 to be maintained at a predetermined depth. The lower end 142 of each raw water/gas-mixing nozzle 14 is immersed in the raw water G in the treatment bath 11. The air introduction opening 143 is located above the water surface Ga of the raw water G in the treatment bath 11 so that air can be smoothly introduced into the raw water/gas-mixing nozzle 14. In this case, the top layer surface of the carriers 10 in the treatment bath 11 is located at a height which is about 40% of the height of the interior of the treatment bath 11, and therefore, is located at a predetermined distance (e.g., about 300 mm) below the lower end 142 (raw water ejection opening) of each raw water/gas-mixing nozzle 14.

The downstream end of an additive feeding pipe 15 for adding an additive to the raw water G in the treatment bath 11 is connected to the raw water pouring pipe 12 on the upstream side thereof from the bifurcation site. An additive supply source 151 is connected to the upstream end of the additive feeding pipe 15. The additive is fed from the additive supply source 151 into the raw water pouring pipe 12 through the additive feeding pipe 15 by an opening/closing operation of a valve 152 which is provided on the additive feeding pipe 15, and is then added to the raw water G in the treatment bath 11 while being stirred in each raw water/gas-mixing nozzle 14.

In this case, as the raw water used is mildly alkaline spring water which contains little iron and has a pH value slightly higher than neutrality. In view of this, an acidic iron solution (iron in a dissolved form) having a pH value lower than neutrality is used as an additive.

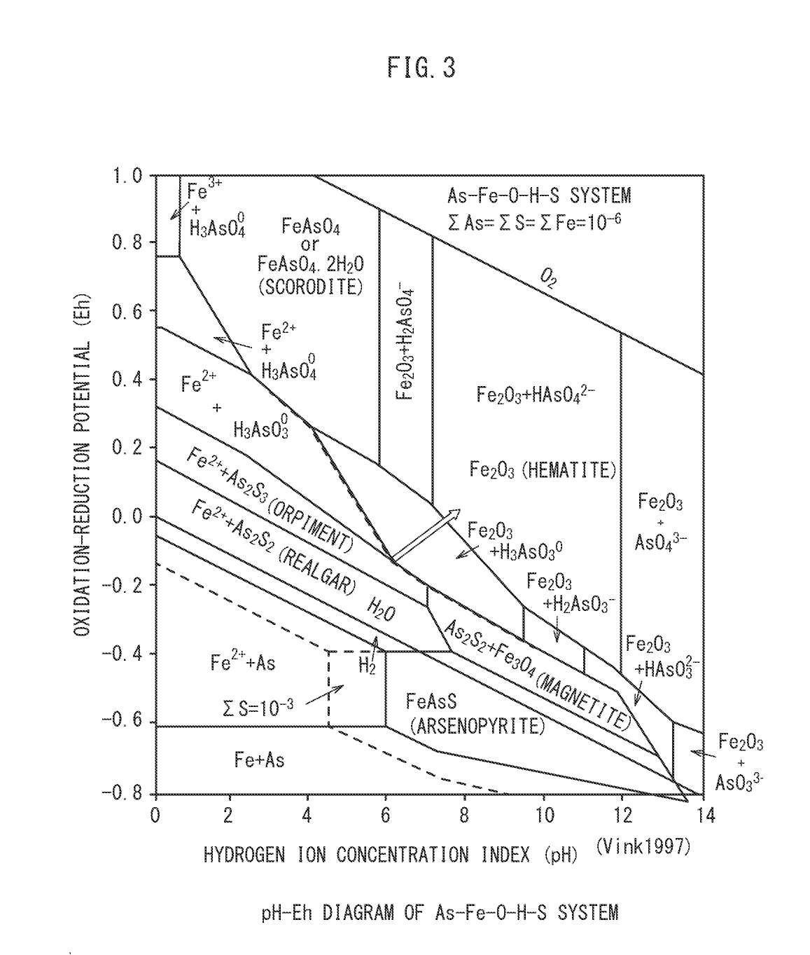

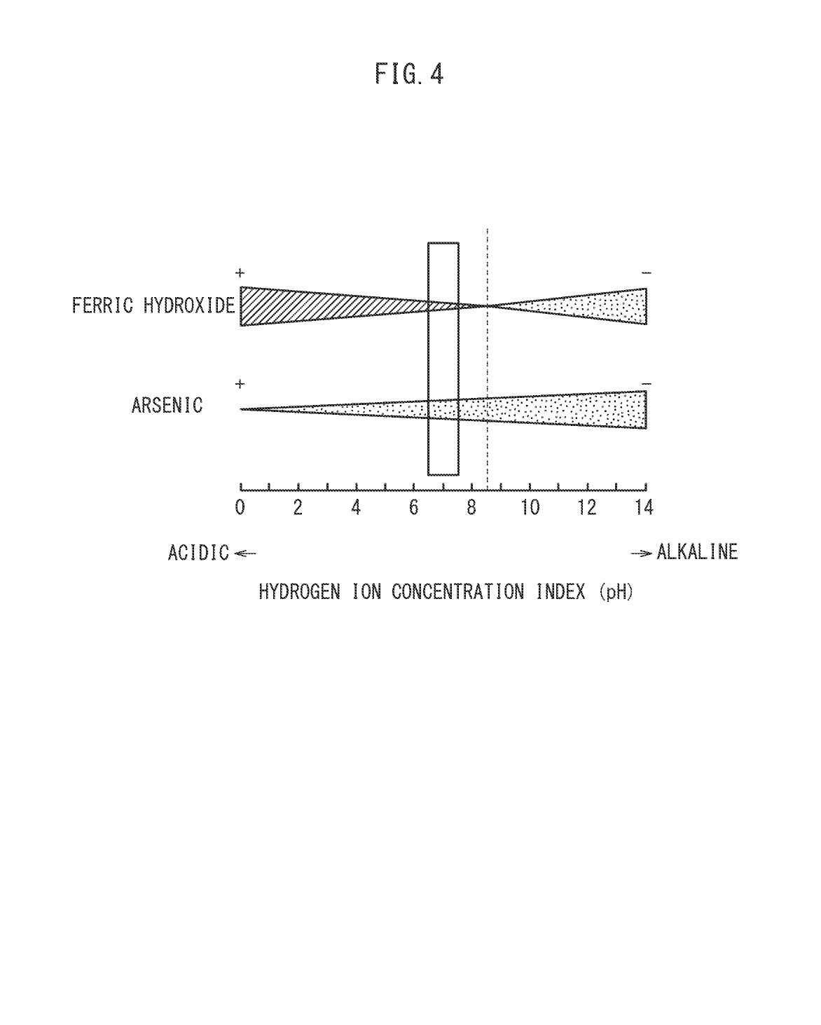

FIG. 3 shows a pH-Eh diagram of an As—Fe—O—H—S system, and FIG. 4 shows a characteristic diagram showing changes in the amounts of surface charge of ferric hydroxide and arsenic due to changes in pH. In FIG. 3, iron more easily exists as ions as the oxidation-reduction potential Eh decreases, i.e., in a further reduced state. Ionic iron does not serve as a carrier for removing arsenic, and therefore, it is necessary to maintain iron in an oxidized state to at least some extent. This is a region (indicated by an outline arrow) to the right of and above a line delimited by a dotted line in FIG. 3. In this case, the pH value of the raw water G such as spring water or the like is typically in the vicinity of neutrality (pH value=7), and therefore, it is necessary to maintain the oxidation-reduction potential Eh at about zero or more (adjustment of oxidation-reduction conditions).

As shown in FIG. 4, the surface charge of ferric hydroxide is positive when the pH value is more acidic than 8.5. Meanwhile, the surface charge of arsenic is negative for all pH values, and the negative surface charge becomes smaller as the pH value becomes more acidic. In view of this, in order to manipulate arsenic so that arsenic is more easily removed, the pH value of the raw water G is adjusted to 6.5-7.5 so that the surface charge of each of ferric hydroxide and arsenic is in a range close to the isoelectric points of ferric hydroxide and arsenic. At this time, the pH value of the raw water Gin the treatment bath 11 may be adjusted to a slightly wider range of 6.5-8.5. In this case, the surface charge of each of ferric hydroxide and arsenic is located in a slightly wider range close to the isoelectric points of ferric hydroxide and arsenic, and therefore, arsenic can be efficiently removed.

The extraction pipe 13 is disposed along the bottom surface of the treatment bath 11, extending in a generally horizontal direction, and is buried in the support gravel material 17. The extraction pipe 13 is used to extract the raw water G in the treatment bath 11 which has been treated with the carriers 10, as treated water, from the treatment bath 11. The extraction pipe 13 has a plurality of holes 131, 131, . . . , and 131 having a smaller diameter than the grain size of the support gravel material 17. The extraction pipe 13 outside the treatment bath 11 is bifurcated or divided into two branches which are provided with valves 132 and 133, respectively. One (corresponding to the valve 132) of the branches of the extraction pipe 13 is connected to an extraction path for extracting the water treated in the treatment bath 11, while the other branch (corresponding to the valve 133) is connected to a supply path for supplying backwashing water to the treatment bath 11. When the water treated in the treatment bath 11 is extracted from the extraction pipe 13 to the extraction path through the one of the branches, the valve 132 on the one of the branches is opened while the valve 133 on the other branch is closed. Meanwhile, when backwashing water from the supply path is supplied from the other branch to the treatment bath 11 through the extraction pipe 13 during backwashing described below, the valve 133 on the other branch is opened while the valve 132 on the one of the branches is closed. As a result, extraction of treated water from the treatment bath 11 and supply of backwashing water to the treatment bath 11 can be smoothly carried out. In this case, the downstream end of the extraction path is connected to a reservoir tank (not shown) for treated water. The upstream end of the supply path is also connected to the reservoir tank so that treated water extracted from the extraction pipe 13 through the extraction path is caused to flow backward from the reservoir tank through the supply path, and is thereby used as backwashing water.

The extraction pipe 13 is also used to supply backwashing water into the treatment bath 11 in order to backwash the carriers 10. When backwashing water is supplied into the treatment bath 11, a pump (not shown) is used. A discharge opening 161 of a discharge pipe 16 is provided at the upper end of the treatment bath 11. The discharge pipe 16 is used when backwashing water which is supplied from the extraction pipe 13 during backwashing of the carrier 10 and overflows in the treatment bath 11 is discharged from the treatment bath 11. In this case, as the backwashing water, treated water extracted from the treatment bath 11 through the extraction pipe 13 is used, and is caused to flow backward back into the treatment bath 11 through the extraction pipe 13. In this case, backwashing of the carriers 10 is conducted once a day, and it takes about 20-30 minutes to complete the backwashing . It is noted that the backwashing water may be any backflow water which flows backward into the treatment bath 11 through the extraction pipe 13. Backwashing water that is supplied from another supply path which is not connected to the reservoir tank for treated water, may be caused to flow backward into the treatment bath 11 through the extraction pipe 13.

Next, an example procedure of a raw water treatment method with the raw water treatment apparatus 1 will be described.

Initially, in a first step, the raw water G saturated with dissolved oxygen is poured from a water pump into the treatment bath 11 through the raw water pouring pipe 12 and the raw water/gas-mixing nozzles 14 while the depth of the raw water G on the top layer surface of the carriers 10 is maintained at a predetermined depth.

Next, in a second step, the pH value of the raw water Gin the treatment bath 11 is measured using a measuring device (not shown). At this time, since mildly alkaline spring water is used as the raw water G, the valve 152 on the additive feeding pipe 15 is operated and opened and an acidic iron solution (iron in a dissolved form) is fed as an additive from the additive supply source 151 into the raw water pouring pipe 12 and is then added to the raw water G in the treatment bath 11 while being stirred in the raw water/gas-mixing nozzles 14, so that the pH value of the raw water G poured into the treatment bath 11 is adjusted to 6.5-7.5.

Thereafter, in a third step, a ferric hydroxide membrane is produced on the entire surfaces of the carriers 10 (mainly in the vicinity of a middle layer portion of the carriers 10) by contact oxidation reaction of dissolved iron, i.e., dissolvable ferrous ions, in the raw water interacting with the oxidizing power of dissolved oxygen introduced by the raw water/gas-mixing nozzles 14 (2Fe²⁺+1/2O₂+4OH⁻+H₂O→2FeOOH·H₂O). At this time, the dissolvable ferrous ions (dissolved iron) in the raw water G form a ferric hydroxide membrane on the entire surface of each of the carriers 10 by contact oxidation reaction. Arsenic in the raw water G adsorbs on the ferric hydroxide.

Thereafter, the ferric hydroxide membrane formed on the entire surface of each of the carriers 10 serves as a catalyst to accelerate the contact oxidation reaction of dissolvable ferrous ions and thereby form ferric hydroxide (2Fe²⁺+1/2O₂+4OH⁻+H₂O→2Fe(OH)₃). Arsenic is reliably captured during the formation of the ferric hydroxide.

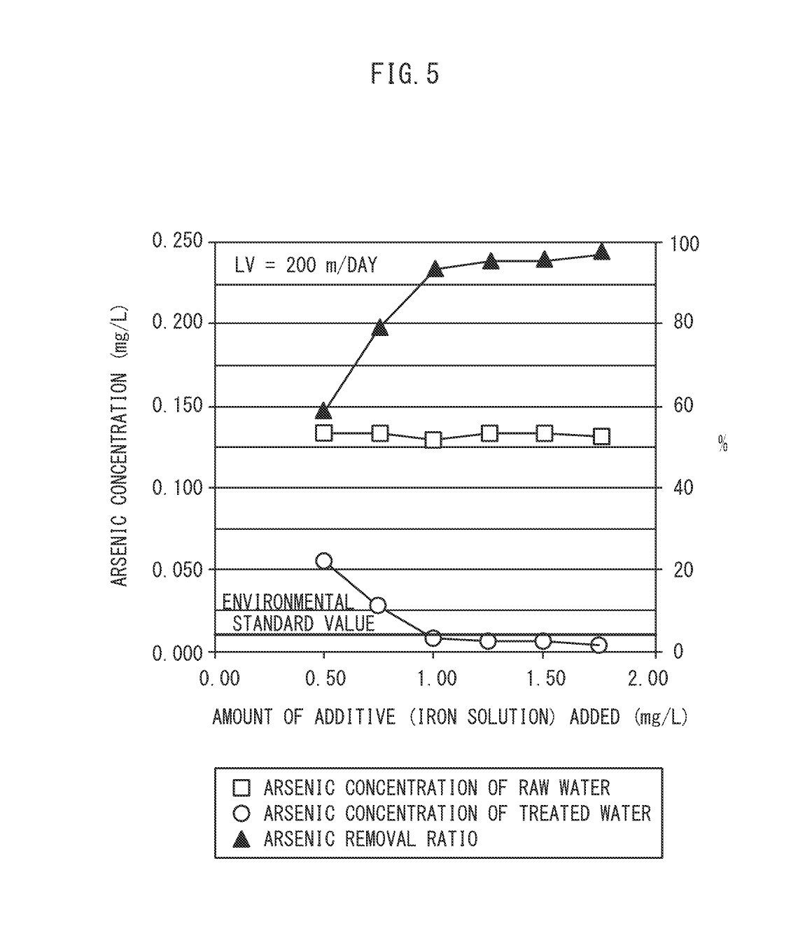

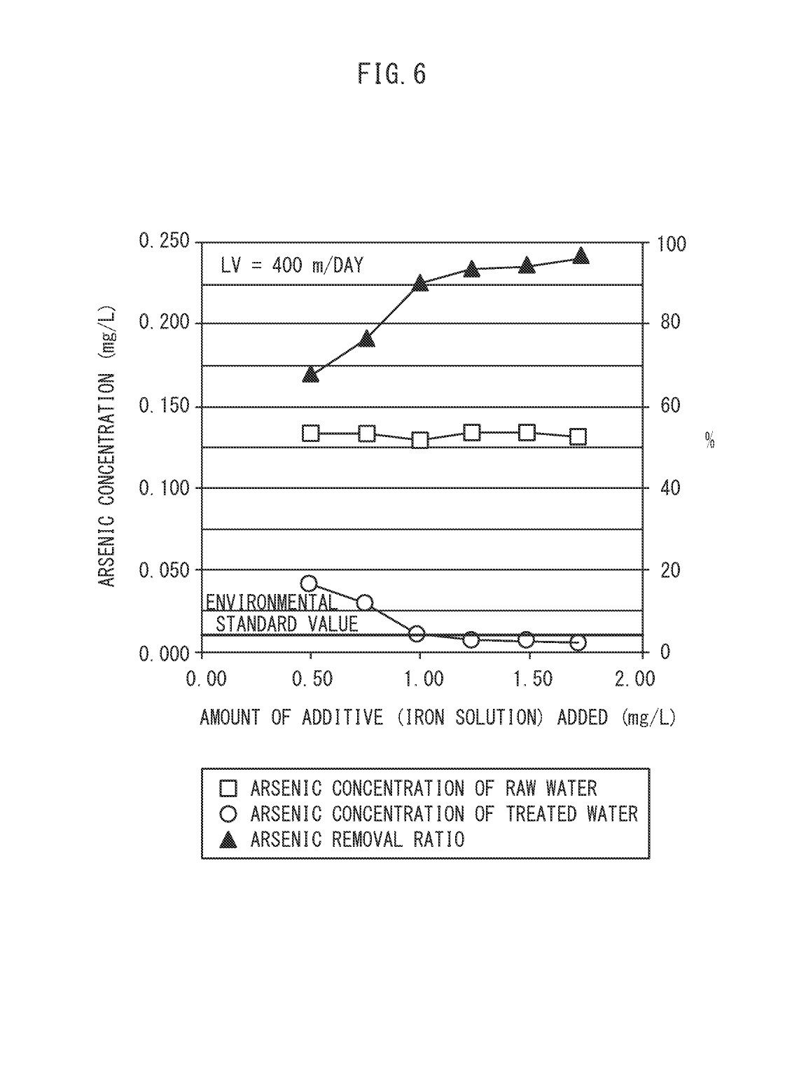

FIG. 5 is a characteristic diagram showing a relationship between the concentration of arsenic and the amount of an additive (iron solution) added in the raw water where the treatment in the treatment bath 11 is conducted at a linear velocity LV of 200 m/day. FIG. 6 is a characteristic diagram showing a relationship between the concentration of arsenic and the amount of an additive (iron solution) added in the raw water where the treatment in the treatment bath 11 is conducted at a linear velocity LV of 400 m/day.

Here, the amount of an additive (acidic iron solution) added to the raw water G in the treatment bath 11 will be described. As can be seen from FIG. 5, when, in the second step, the raw water G in the treatment bath 11 is treated at a high rate (linear velocity LV=200 m/day), then if 1.0 mg/L of the iron solution is added with respect to an arsenic concentration of 0.13 mg/L in the raw water arsenic can be treated so that the arsenic concentration after the treatment is lower than or equal to an environmental standard value. At this time, the iron/arsenic ratio (Fe/As) is found to be about 8.3. Meanwhile, as can be seen from FIG. 6, when, in the second step, the raw water G in the treatment bath 11 is treated at a higher rate (linear velocity LV=400 m/day), then if 1.25 mg/L of the additive is added with respect to an arsenic concentration of 0.13 mg/L in the raw water arsenic can be treated so that the arsenic concentration after the treatment is lower than or equal to the environmental standard value. At this time, the iron/arsenic ratio (Fe/As) is found to be about 10. It is also found that, at this time, if, in the second step, the raw water G in the treatment bath 11 is treated at a high rate (linear velocity LV=200 or 400 m/day), ferric hydroxide in a suspended form cannot be produced in the raw water G, and therefore, if it is not desirable to produce ferric hydroxide in a suspended form in the raw water the raw water G in the treatment bath 11 may be treated at a high rate where the linear velocity LV is 200 m/day or more.

Thereafter, the ferric hydroxide, and the arsenic captured due to the formation of the ferric hydroxide, are caused to adsorb on the entire surfaces of the carriers 10 and thereby removed from the raw water Gin the treatment bath 11, and the resultant treated water is discharged from the treatment bath 11 through the extraction pipe 13. This is repeatedly conducted. After about one day has passed, backwashing of the carriers 10 is conducted for about 20-30 minutes. Through the backwashing, the ferric hydroxide formed on the entire surfaces of the carriers 10 and the arsenic captured due to the formation of the ferric hydroxide, are removed from the surfaces of the carriers 10 by the flow of backwashing water, and then discharged together with the backwashing water overflowing in the treatment bath 11, from the treatment bath 11 through the discharge pipe 16.

Thus, in this embodiment, the pH value of the raw water G poured in the treatment bath 11 is adjusted to 6.5-7.5 by adding an additive such as an acidic iron solution to the raw water a ferric hydroxide membrane is formed on the entire surfaces of the carriers 10 by contact oxidation reaction of dissolved iron, i.e., dissolvable ferrous ions, in the adjusted raw water and arsenic in the raw water G is caused to adsorb on the ferric hydroxide. At this time, when the ferric hydroxide membrane on the surfaces of the carriers 10 serves as a catalyst to accelerate contact oxidation reaction of dissolvable ferrous ions and thereby form ferric hydroxide, arsenic adsorbed on the ferric hydroxide is reliably captured. Therefore, compared to the situation where arsenic ions are electrically adsorbed only around ferric hydroxide in a suspended form produced in raw water, arsenic ions are electronically adsorbed on or complexed with ferric hydroxide which is produced on the entire surfaces of the carriers 10 by contact oxidation reaction of iron in a dissolved form in the raw water G on the surfaces of the carriers 10, whereby arsenic in the raw water G can be considerably efficiently captured.

At this time, when the raw water G is treated at a high rate (linear velocity LV=200 m/day), the amount of an additive (acidic iron solution) added to the raw water G in the treatment bath 11 is only 1.0 mg/L with respect to the arsenic concentration of 0.13 mg/L in the raw water G Meanwhile, when the raw water G is treated at a higher rate (linear velocity LV=of 400 m/day), the amount of an additive (acidic iron solution) added to the raw water G in the treatment bath 11 is only 1.25 mg/L with respect to the arsenic concentration of 0.13 mg/L in the raw water G As a result, if the iron/arsenic ratio (Fe/As) is about 8.3 to about 10, arsenic can be treated so that the arsenic concentration after the treatment is lower than or equal to the environmental standard value. Therefore, the iron/arsenic ratio (Fe/As) of 12 would be sufficient for safety. Compared to the situation where arsenic ions are electrically adsorbed only around ferric hydroxide in a suspended form, and therefore, the iron/arsenic ratio (Fe/As) is 100-200, the amount of an additive added can be significantly reduced by a factor of about 10-20. As a result, an increase in the operating cost can be significantly reduced by a significant reduction in the additive during removal of arsenic by the raw water treatment apparatus 1. In addition, the amount of waste additives can be significantly reduced.

In addition, it is guaranteed that the raw water G is treated at a high rate where the linear velocity LV is as high as 400 m/day, and therefore, sufficient capability of treatment of the raw water G can be ensured.

In addition, the raw water G saturated with dissolved oxygen is poured into the treatment bath 11 through the raw water/gas-mixing nozzles 14, and therefore, the production of ferric hydroxide on the surfaces of the carriers 10 from dissolved iron in the raw water G is facilitated by interaction with the oxidizing power of the dissolved oxygen without the need of exposure to air, whereby iron can be efficiently oxidized without the production of colloidal silica iron even when silica or the like is contained in the raw water G.

Moreover, treated water which is extracted from the treatment bath 11 through the extraction pipe 13 is caused to flow back to the treatment bath 11 on a regular basis for backwashing of the carriers 10, whereby ferric hydroxide produced on the surfaces of the carriers 10 can be washed out together with arsenic adsorbed on the ferric hydroxide with backwashing water (treated water), and discharged from the treatment bath 11 through the discharge pipe 16, and therefore, the carriers 10 can continue to exhibit the effect of treating the raw water G

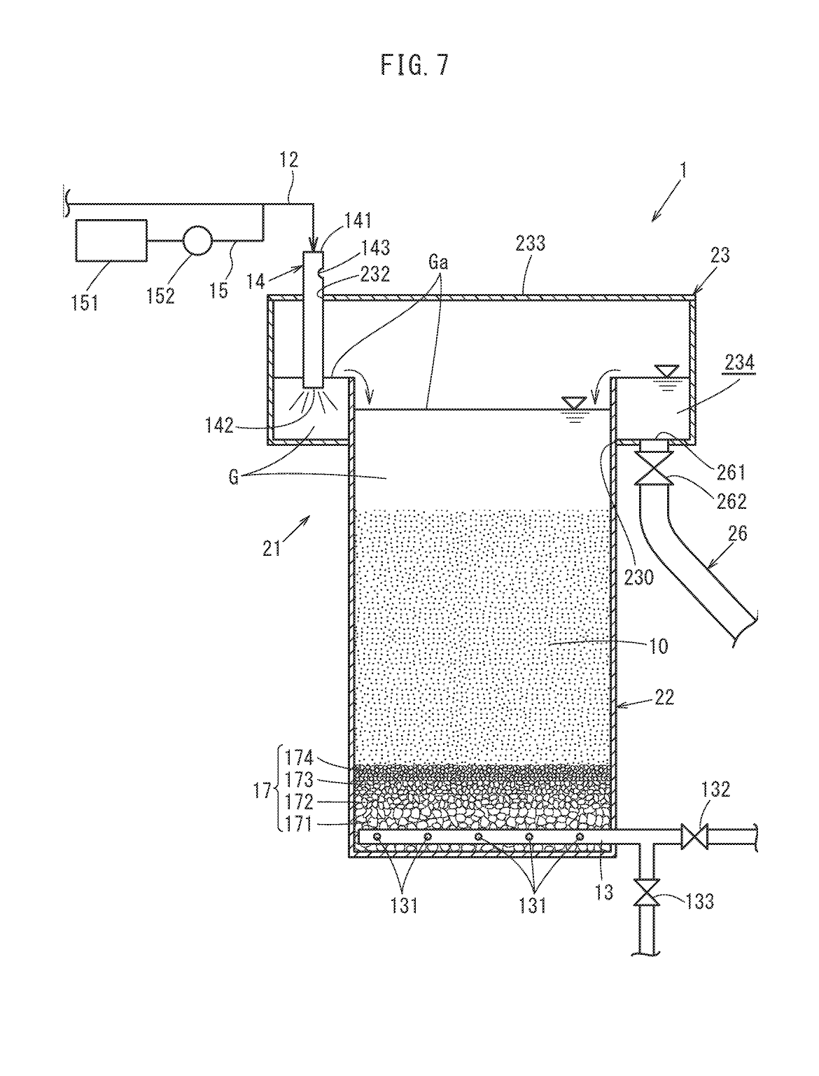

It is noted that the present disclosure is not limited to the above embodiments, and encompasses other various variations. For example, although, in the above embodiments, the treatment bath 11 having a tube-like shape which is rectangular as viewed from above is used, a treatment bath 21 having a tube-like shape which is circular as viewed from above may be used as shown in FIG. 7. The treatment bath 21 includes a treatment bath main-body 22 in the shape of a cylinder closed at the bottom end, and a treatment bath sub-body 23 which covers an upper end portion of the treatment bath main-body 22 and has a diameter larger than that of the treatment bath main-body 22. The treatment bath sub-body 23 includes: a lower member 231 which is in the shape of a cylinder closed at the bottom end and has a hole portion 230 having almost the same size as the outer diameter of the treatment bath main-body 22, in the vicinity of the center of the bottom thereof; and an upper member 233 which has a generally disc shape, closes the opening of the lower member 231 from above, and has insertion holes 232 through which the respective raw water/gas-mixing nozzles 14 are inserted. The lower member 231 of the treatment bath sub-body 23 is welded on an upper end portion of the treatment bath main-body 22 in a watertight manner with the hole portion 230 inserted on the outer surface of the treatment bath main-body 22. The raw water G from the raw water/gas-mixing nozzles 14 is temporarily stored in an annular reservoir portion 234 around the outer surface of the treatment bath main-body 22, and overflows from the upper end of the treatment bath main-body 22 into the treatment bath main-body 22. A discharge opening 261 of a discharge pipe 26 for discharging, from the reservoir portion 234, backwashing water which has been supplied from the extraction pipe 13 and then overflowed from the upper end of the treatment bath main-body 22 into the reservoir portion 234 during backwashing of the carriers 10, is connected to the bottom of the lower member 231. The backwashing water is discharged from the reservoir portion 234 by an opening operation of a valve 262 provided on the discharge pipe 26.

In the above embodiments, an acidic iron solution (iron in a dissolved form) is fed as an additive into the raw water pouring pipe 12 so that the pH value of the raw water G poured in the treatment bath 11 is adjusted to 6.5-7.5. Alternatively, an acidic iron solution (iron in a dissolved form) may be fed as an additive from an additive supply source into the raw water pouring pipe so that the pH value of the raw water G poured in the treatment bath 11 is adjusted to 6.5-8.5. In this case, arsenic and iron in a dissolved form are efficiently attracted by each other in a range close to the isoelectric points of arsenic and iron in a dissolved form, so that arsenic is sufficiently adsorbed on ferric hydroxide membrane covering the entire surfaces of the carriers, and therefore, arsenic in the raw water can be efficiently captured together with iron.

Also, in the above embodiments, as the raw water mildly alkaline spring water which contains little iron and therefore has a pH value slightly higher than neutrality is used. Alternatively, as the raw water, acidic spring water which contains an excessive amount of iron and therefore has a pH value lower than neutrality may be used. In this case, an alkaline solution needs to be fed as an additive into the raw water pouring pipe instead of an acidic solution so that the pH value of the raw water poured in the treatment bath is 6.5-7.5 (or 6.5-8.5).

What is claimed is:

1. A raw water treatment method comprising:
a first step of pouring raw water containing arsenic in an amount exceeding an environmental standard value, into a treatment bath filled with particulate carriers;
a second step of treating the raw water poured in the treatment bath by the first step at a flow rate which does not allow production of ferric hydroxide in a suspended form in the raw water while adding an acidic or alkaline solution to the raw water in the treatment bath so that the pH value of the raw water is adjusted to 6.5-8.5; and
a third step of capturing the arsenic in the raw water by producing a membrane of ferric hydroxide on surfaces of the carriers by contact oxidation reaction of iron in a dissolved form which is added to or present in the raw water adjusted by the second step, to cause the arsenic in the raw water to be adsorbed on or complexed with the produced ferric hydroxide.

2. The raw water treatment method according to claim 1, wherein in the second step, the pH value of the raw water in the treatment bath is adjusted to 6.5-7.5.

3. The raw water treatment method according to claim 1, wherein
in the first step, the raw water is poured into the treatment bath through one end of a raw water/gas-mixing nozzle having an air introduction opening at an intermediate point along the nozzle and having another end connected to a raw water pouring pipe, from above, while air is introduced through the air introduction opening by the ejector effect of the raw water/gas-mixing nozzle sending the raw water at high pressure through the one end of the nozzle, and is mixed with the raw water so that the concentration of dissolved oxygen in the raw water is saturated.

4. The raw water treatment method according to claim 2, wherein
in the first step, the raw water is poured into the treatment bath through one end of a raw water/gas-mixing nozzle having an air introduction opening at an intermediate point along the nozzle and having another end connected to a raw water pouring pipe, from above, while air is introduced through the air introduction opening by the ejector effect of the raw water/gas-mixing nozzle sending the raw water at high pressure through the one end of the nozzle, and is mixed with the raw water so that the concentration of dissolved oxygen in the raw water is saturated.

5. The raw water treatment method according to claim 1, wherein treated water after the third step or washing water is caused to flow back into the treatment bath on a regular basis for backwashing of the carriers.

6. The raw water treatment method according to claim 2, wherein treated water after the third step or washing water is caused to flow back into the treatment bath on a regular basis for backwashing of the carriers.

7. The raw water treatment method according to claim 3, wherein treated water after the third step or washing water is caused to flow back into the treatment bath on a regular basis for backwashing of the carriers.

8. The raw water treatment method according to claim 4, wherein treated water after the third step or washing water is caused to flow back into the treatment bath on a regular basis for backwashing of the carriers.
